(19) United States
(12) Patent Application Publication
(10) Pub. No.: US 2013/0088664 A1
(43) Pub. Date: Apr. 11, 2013

(54) LIQUID CRYSTAL DISPLAY DEVICE

(71) Applicant: Masayuki Ohhashi, Osaka-shi (JP)

(72) Inventor: Masayuki Ohhashi, Osaka-shi (JP)

(73) Assignee: Sharp Kabushiki Kaisha, Osaka-shi ,Osaka (JP)

(21) Appl. No.: 13/700,677

(22) PCT Filed: Mar. 22, 2011
(86) PCT No.: PCT/JP2011/056797

§ 371 Date: Nov. 28, 2012

(30) Foreign Application Priority Data
Jun. 21, 2010 (JP) 2010-140666

(51) Int. Cl. G02F 1/1335

(52) U.S. Cl. CPC G02F 1/1336
USPC 349/62; 349/61

(57) ABSTRACT

A flexible printed circuit board (20) connected to a liquid crystal panel (10) is folded back so as to overlap the back surface of an illuminating device (30). A surface treatment for preventing mutual interference between the flexible printed circuit board and a sheet (34) that constitutes the illuminating device and faces the flexible printed circuit board is applied to at least part of an area of the flexible printed circuit board that faces the sheet or at least part of an area of the sheet that faces the flexible printed circuit board. This configuration can suppress the occurrence of non-uniform brightness due to temperature changes.

### REFERENCE TO RELATED APPLICATIONS

This application is a national stage application under 35 USC 371 of International Application No. PCT/JP2011/056797, filed Mar. 22, 2011, which claims the priority of Japanese Patent Application No. 2010-140666, filed Jun. 21, 2010, the entire contents of which are incorporated herein by reference.

### FIELD OF THE INVENTION

The present invention relates to a liquid crystal display device including a liquid crystal panel, a flexible printed circuit board that is connected to the liquid crystal panel, and an illuminating device that illuminates the liquid crystal panel.

### BACKGROUND OF THE INVENTION

In a liquid crystal display device including a transmission type liquid crystal panel, an illuminating device (so-called backlight device) is located on the opposite side (back side) of the liquid crystal panel from the viewing side. Moreover, a flexible printed circuit board is connected to the liquid crystal panel to drive the liquid crystal panel.

In the case of a small thin liquid crystal display device used for a portable telephone, a personal data assistant (PDA), etc., the flexible printed circuit board can be arranged so that it is folded on the back side of the liquid crystal panel (see, e.g., Patent Documents 1, 2).
Patent Document 1: JPH11 (1999)-249583 A
Patent Document 2: JP 2002-076559 A

### SUMMARY OF THE INVENTION

However, when an environmental temperature test is performed on a liquid crystal display device, in which the flexible printed circuit board is arranged so as to overlap the back surface (i.e., the surface on the opposite side from the liquid crystal panel) of the illuminating device, by exposing the liquid crystal display device alternately to high and low temperatures, there is a problem that non-uniform brightness occurs on the display surface.

The study conducted by the present inventors has revealed that the causes of this non-uniform brightness are roughly as follows.

In general, the flexible printed circuit board has a configuration in which a copper wiring pattern is formed on a base sheet made of a flexible insulating resin, and an insulating layer is further formed to cover the entire surface of the base sheet. Since such a flexible printed circuit board is folded back so as to overlap the back surface of the illuminating device, the insulating layer on the surface of the flexible printed circuit board adheres to a sheet (e.g., a reflecting sheet) that is disposed on the back surface of the illuminating device and is adjacent to the insulating layer. The flexible printed circuit board and the sheet have different coefficients of thermal expansion. Therefore, a difference in thermal expansion between the flexible printed circuit board and the sheet occurs due to temperature changes, and both the flexible printed circuit board and the sheet are deformed. The deformation of the sheet thus generated leads to non-uniform brightness of the illuminating device, which results in non-uniform brightness on the display surface of the liquid crystal display device.

The adhesion between the flexible printed circuit board and the sheet can be prevented by placing them apart so that the flexible printed circuit board does not come into contact with the sheet. However, this makes the liquid crystal display device thicker.

The present invention solves the above conventional problem and has an object of suppressing the occurrence of non-uniform brightness due to temperature changes in a liquid crystal display device in which a flexible printed circuit board is folded back so as to overlap the back surface of an illuminating device.

A liquid crystal display device of the present invention includes a liquid crystal panel, a flexible printed circuit board that is connected to the liquid crystal panel, and an illuminating device that illuminates the liquid crystal panel. The flexible printed circuit board is folded back so as to overlap a surface of the illuminating device that is on the opposite side from the liquid crystal panel. A surface treatment for preventing mutual interference between the flexible printed circuit board and a sheet that constitutes the illuminating device and faces the flexible printed circuit board is applied to at least part of an area of the flexible printed circuit board that faces the sheet or at least part of an area of the sheet that faces the flexible printed circuit board.

In the present invention, the surface treatment for preventing mutual interference between the flexible printed circuit board and the sheet is applied to the surface of at least one of the adjacent flexible printed circuit board and the sheet that faces the other. Therefore, even if the flexible printed circuit board and the sheet have different coefficients of thermal expansion, the flexible printed circuit board and the sheet can freely change their dimensions without being constrained by each other when the temperature changes. Thus, the sheet is not deformed due to temperature changes. Accordingly, the present invention can suppress the occurrence of non-uniform brightness in the illuminating device, and consequently can suppress the occurrence of non-uniform brightness on the display surface of the liquid crystal display device.

Moreover, it is not necessary to place the flexible printed circuit board and the sheet apart to avoid mutual interference. Thus, the present invention can reduce the thickness of the liquid crystal display device.

### BRIEF DESCRIPTION OF THE DRAWINGS

FIG. 1 is an exploded perspective view showing a schematic configuration of a liquid crystal display device according to Embodiment 1 of the present invention.

FIG. 2 is an exploded perspective view showing a state in which a flexible printed circuit board connected to a liquid crystal panel is folded on the back side of an illuminating device in a liquid crystal display device according to Embodiment 1 of the present invention.

FIG. 3 is a plan view showing the surface of a flexible printed circuit board that is to face an illuminating device when used in a liquid crystal display device according to Embodiment 1 of the present invention.

FIG. 4A is a plan view showing the surface of a flexible printed circuit board that is to face an illuminating device when used in a liquid crystal display device according to Embodiment 2 of the present invention.

FIG. 4B is a plan view showing the surface of another flexible printed circuit board that is to face an illuminating device when used in a liquid crystal display device according to Embodiment 2 of the present invention.

FIG. 4C is a plan view showing the surface of yet another flexible printed circuit board that is to face an illuminating device when used in a liquid crystal display device according to Embodiment 2 of the present invention.

### DETAILED DESCRIPTION OF THE INVENTION

In the present invention, the surface treatment applied to the flexible printed circuit board or the sheet prevents mutual interference between the flexible printed circuit board and the sheet. In the context of the present invention, the “mutual interference” means that when the flexible printed circuit board and the sheet differ in the amount of dimensional change associated with changes in the environment such as temperature and humidity, at least one of the flexible printed circuit board and the sheet causes a change in shape such as deformation due to the difference in the amount of dimensional change. The mutual interference between the flexible printed circuit board and the sheet may occur, e.g., when the flexible printed circuit board adheres to the sheet, or when a coefficient of friction between the flexible printed circuit board and the sheet is large.

In the present invention, it is preferable that the surface treatment is silk printing. With this method, the surface treatment can be easily applied in a desired pattern. Moreover, when an identification number or the like is printed on the flexible printed circuit board or the sheet by silk printing, the surface treatment can be applied at the same time as that silk printing. Therefore, another process for the surface treatment is not necessary.

The surface treatment may be an attachment of a resin sheet. Thus, using a dry process, the surface treatment can be easily applied in a desired pattern.

The sheet is preferably a reflecting sheet. Thus, it is possible to prevent deformation of the reflecting sheet due to mutual interference with the flexible printed circuit board. Therefore, non-uniform brightness of the illuminating device can be further reduced.

Hereinafter, the present invention will be described in detail by way of preferred embodiments. It should be noted that the present invention is not limited to the following embodiments. For convenience of explanation, each of the drawings that are to be referred to in the following description schematically shows only the main members required to describe the present invention, among the constituent members of the embodiments of the present invention. Therefore, the present invention can include any constituent members that are not shown in the following drawings. The size of and size ratio of each of the members in the following drawings do not exactly reflect those of the actual constituent members.

### Embodiment 1

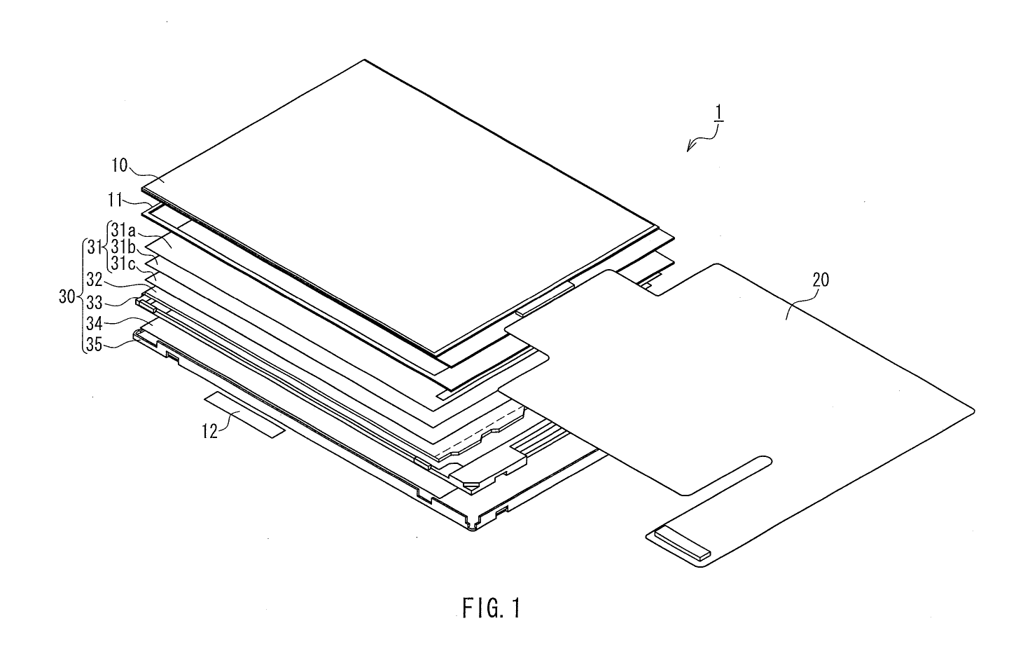

FIG. 1 is an exploded perspective view showing a schematic configuration of a liquid crystal display device 1 according Embodiment 1 of the present invention. The liquid crystal display device 1 of Embodiment 1 includes a liquid crystal panel 10, a flexible printed circuit board (referred to as “FPC” in the following) 20 that is connected to the liquid crystal panel 10, and an illuminating device 30 that illuminates the liquid crystal panel 10.

The liquid crystal panel 10 is not particularly limited and can be, e.g., a known transmission type liquid crystal panel. The liquid crystal panel 10 of Embodiment 1 includes a pair of opposing translucent substrates and a liquid crystal sealed between the translucent substrates. Polarizing plates are formed on the surfaces of the respective translucent substrates that face away from the liquid crystal. A driving signal for allowing the liquid crystal panel 10 to perform desired display is input to the liquid crystal panel 10 via the FPC 20. The liquid crystal panel 10 is bonded and fixed to the upper surface of a holder 33 (as will be described later) with a double-sided tape 11 provided in the form of a rectangular frame.

The FPC 20 is not particularly limited and can be, e.g., a known flexible printed circuit board. In this embodiment, the FPC 20 has a configuration in which a wiring pattern made of a conductive material such as a copper foil is formed on both sides of a base sheet made of a resin material with flexibility and insulating properties such as polyimide, and an insulating layer (generally called PSC (photosensitive cover lay film)) is further formed to cover the entire surface of the base sheet. The insulating layer can be, e.g., a polyester resin. An integrated circuit (IC) or the like for driving the liquid crystal panel 10 may be mounted on the FPC 20. The whole shape of the FPC 20 is not particularly limited. One end of the FPC 20 is connected to one of the translucent substrates constituting the liquid crystal panel 10, and the other end is provided with a terminal to be connected to a drive circuit for driving the liquid crystal panel 10.

The illuminating device 30 includes, from the liquid crystal panel 10 side, an optical sheet 31, a light guide plate 32, a holder 33, a reflecting sheet 34, and a rear bezel 35.

The light guide plate 32 is a plate-like body made of a synthetic resin such as a transparent acrylic resin (e.g., PMMA). The light guide plate 32 has a pair of principal surfaces that are substantially rectangular in shape and face each other, and one of the pair of principal surfaces that is located on the liquid crystal panel 10 side is a light emission surface. A light source (not shown) is located opposite one or more of four sides that connect the pair of principal surfaces of the light guide plate 32. The light source is not particularly limited and can be, e.g., an LED. Light emitted from the light source enters one or more of the sides of the light guide plate 32 located opposite the light source, and is diffused while being totally reflected in the light guide plate 32 and thus propagates. The diffused light emanates from the light emission surface that faces the liquid crystal panel 10.

The optical sheet 31 of this embodiment includes three sheets, i.e., lens sheets 31a, 31b and a diffusion sheet 31c from the liquid crystal panel 10 side.

Each of the lens sheets 31a, 31b has, e.g., a fine prism pattern formed on the surface that faces the liquid crystal panel 10, and improves the brightness in the front direction.

The diffusion sheet 31c has fine irregularities or the like formed on one surface, and diffuses light passing through it.

The above configuration of the optical sheet 31 is merely an example, and the present invention is not limited thereto. The number of sheets constituting the optical sheet 31 is not limited to 3, and may be larger or smaller than this. The functions of the optical sheet are not limited to the above. At least one of the sheets 31a, 31b, 31c may be omitted, or another sheet having the function other than those described above may be further added. Alternatively, a single sheet may have a plurality of functions.

The reflecting sheet 34 faces the principal surface of the light guide plate 32 that is on the opposite side of the light emission surface, and allows the light that has leaked from the light guide plate 32 to reenter the light guide plate 32, thereby achieving the effective utilization of light. The reflecting sheet 34 is not particularly limited and can be, e.g., a known reflecting sheet that can be used for the illuminating device. Moreover, the material of the reflecting sheet 34 is not particularly limited and can be, e.g., an acrylic resin. The reflecting sheet 34 may be composed of a plurality of sheets.

The holder 33 is a substantially rectangular frame body having an opening in the center. The holder 33 can be produced, e.g., by injection molding of a synthetic resin material such as polycarbonate.

The rear bezel 35 can be produced, e.g., by bending and molding a metal plate into a predetermined shape by press molding or the like.

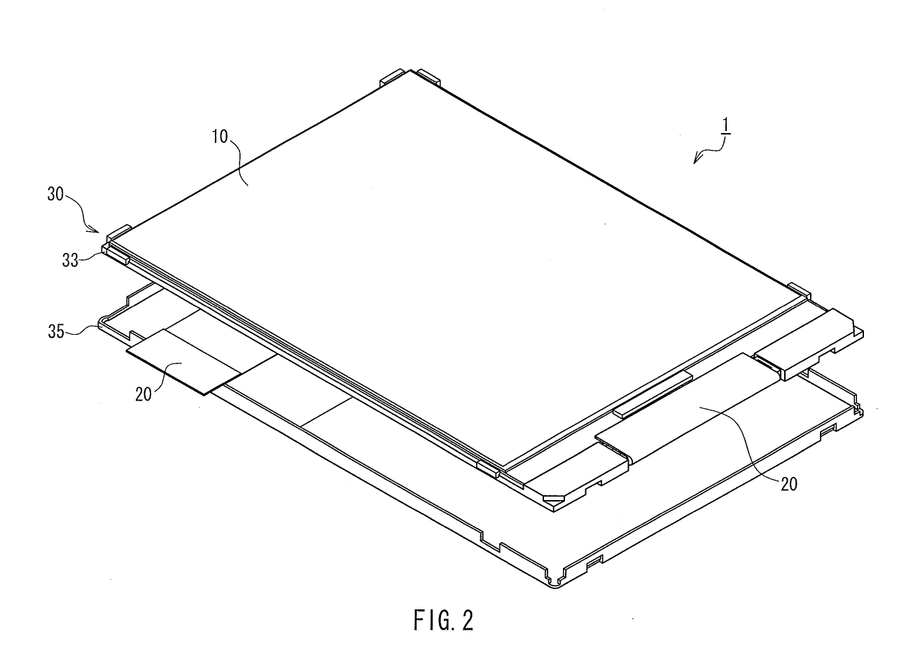

The light guide plate 32 and the optical sheet 31 are placed in this order on the holder 33, to which the liquid crystal panel 10 is further fixed via the double-sided tape 11. Moreover, the reflecting sheet 34 is located opposite the light guide plate 32 exposed in the center opening of the holder 33. Then, the FPC 20 is folded back so as to overlap the back surface (i.e., the surface on the opposite side from the liquid crystal panel 10) of the reflecting sheet 34. The folded FPC 20 is fixed to the holder 33 with a double-sided tape 12 made of a resin such as PET (polyethylene terephthalate). FIG. 2 is a perspective view showing this state. The laminated structure is fitted into and held by the rear bezel 35. Thus, the liquid crystal display device 1 of Embodiment 1 is provided.

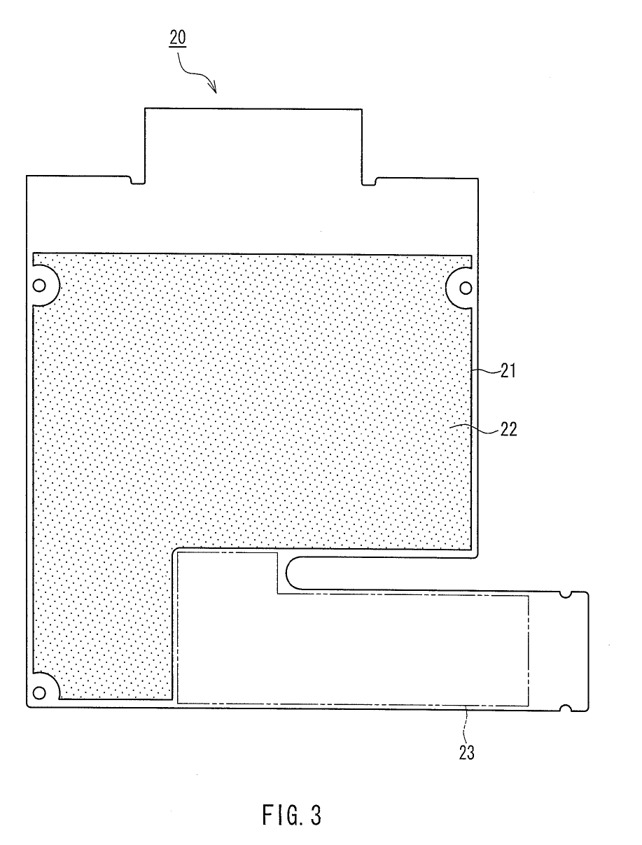

In the liquid crystal display device 1 of Embodiment 1, the FPC 20 overlaps the back surface of the reflecting sheet 34. Therefore, the FPC 20 may come into contact with the reflecting sheet 34. However, in Embodiment 1, as shown in FIG. 3, a surface treatment 22 for preventing mutual interference between the FPC 20 and the reflecting sheet 34 is applied to the surface of an area 21 in a region of the FPC 20 that is to face the reflecting sheet 34.

In Embodiment 1, a resin layer is formed as the surface treatment 22. The material of the resin layer is preferably a material that has good slidability with respect to the reflecting sheet 34 and does not adhere to the reflecting sheet 34, and can be appropriately selected in accordance with the material or the like of the reflecting sheet 34. For example, a urethane resin can be used.

The method for forming the resin layer is not particularly limited, but a printing method, particularly a silk printing method is preferred because the resin layer can be easily formed in a desired pattern. In general, a terminal number or a product number is often printed on the surface of the FPC 20 by the silk printing method. Therefore, when the silk printing method is used to form the resin layer, the resin layer can be formed without the need to provide another process separately.

The thickness of the resin layer printed as the surface treatment 22 is not particularly limited, but is preferably as small as possible so that the lower limit of the thickness is 10 μm or more.

In Embodiment 1, the surface treatment 22 applied to the area 21 of the FPC 20 prevents the insulating layer on the surface of the FPC 20 from coming into close contact with and adhering to the reflecting sheet 34. Therefore, even if the FPC 20 and the reflecting sheet 34 have different coefficients of thermal expansion, and therefore differ in the amount of dimensional change associated with changes in ambient temperature, the FPC 20 and the reflecting sheet 34 can freely change their dimensions without being constrained by each other. Thus, unlike the above conventional liquid crystal display device, the reflecting sheet 34 is not deformed due to temperature changes. Accordingly, this embodiment can suppress the occurrence of non-uniform brightness in the illuminating device 30, and consequently can suppress the occurrence of non-uniform brightness on the display surface of the liquid crystal display device 1.

In Embodiment 1, the surface treatment 22 prevents adhesion between the FPC 20 and the reflecting sheet 34. Therefore, it is not necessary to place the FPC 20 and the reflecting sheet 34 apart, so that the thickness of the liquid crystal display device 1 can be reduced.

The surface treatment 22 is applied in the area of the FPC 20 that is to face the reflecting sheet 34. However, the surface treatment 22 does not need to be applied in the entire area of the FPC 20 that is to face the reflecting sheet 34.

For example, if a layer other than the surface treatment 22 is formed on the insulating layer on the surface of the FPC 20, the surface treatment 22 can be omitted. For example, in FIG. 3, a silver shielding layer (not shown) is formed in an area 23 of the FPC 20 that is surrounded by an alternate long and two short dashes line. Therefore, since the insulating layer on the surface of the FPC 20 is not exposed in the area 23, the insulating layer will not come into contact with the reflecting sheet 34. Thus, the surface treatment 22 can be omitted in the area 23.

Moreover, the surface treatment 22 can be omitted in the area near the edge around the FPC 20. This is because even if the insulating layer of the FPC 20 remains exposed in this area, it is not likely that the insulating layer adheres to the reflecting sheet 34.

### Embodiment 2

Embodiment 2 differs from Embodiment 1 in the pattern of the surface treatment applied to the FPC 20. Hereinafter, Embodiment 2 will be described mainly in terms of the difference with Embodiment 1.

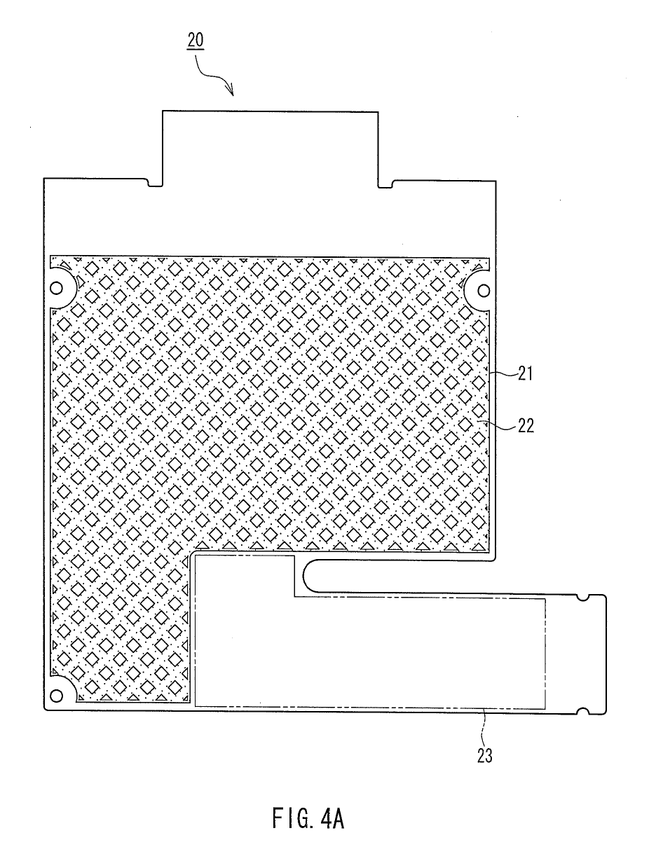

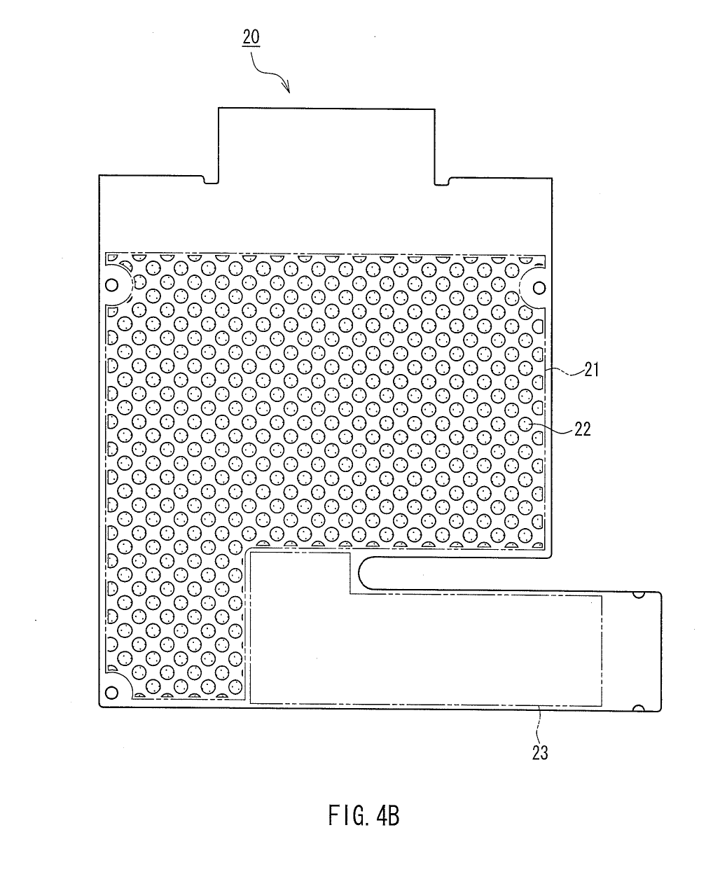

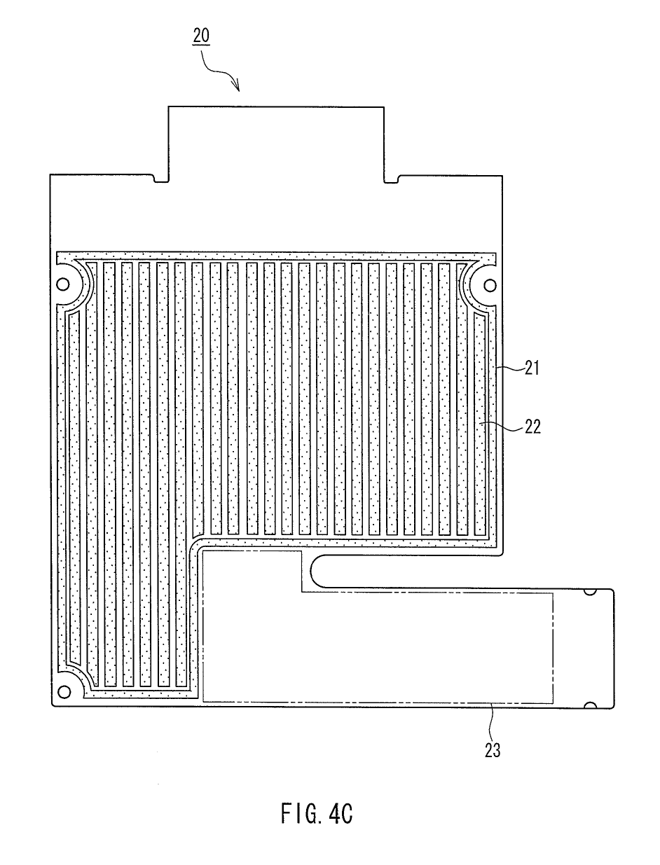

In Embodiment 1, as shown in FIG. 3, the surface treatment 22 is uniformly applied to the area 21 of the FPC 20 that is to face the reflecting sheet 34. In Embodiment 2, the surface treatment 22 is formed in a predetermined pattern in the area 21. FIG. 4A is a plan view showing the surface of the FPC 20 that is to face the illuminating device 30 when used in a liquid crystal display device according to Embodiment 2. In the example of FIG. 4A, the surface treatment 22 is applied in a mesh pattern in the area 21. In the area 21, the insulating layer on the surface of the FPC 20 is exposed in many substantially rectangular micro areas where the surface treatment 22 is not applied.

In the example of FIG. 4A, the surface treatment 22 is formed in a mesh pattern. However, the present invention is not limited thereto.

For example, as shown in FIG. 4B, the surface treatment 22 may be discretely applied in a dot pattern in the area 21. In the area 21 of FIG. 4B, the insulating layer on the surface of the FPC 20 is exposed in the portion other than the circular areas of the individual dots where the surface treatment 22 is applied.

Alternatively, as shown in FIG. 4C, the surface treatment 22 may be discretely applied in a plurality of stripes in the area 21. In the area 21 of FIG. 4C, the insulating layer on the surface of the FPC 20 is exposed in the area where the surface treatment 22 is not applied.

In Embodiment 2, since the surface treatment 22 is partially applied in the area 21 of the FPC 20, the insulating layer on the surface of the FPC 20 is exposed to the reflecting sheet 34 in the area 21. However, it is possible to prevent adhesion between the insulating layer on the surface of the FPC 20 and the reflecting sheet 34 by appropriately setting the area of the insulating layer to be exposed and the thickness of the resin layer formed by printing as the surface treatment 22. Therefore, like Embodiment 1, this embodiment can prevent deformation of the reflecting sheet 34 due to temperature changes. Accordingly, this embodiment can suppress the occurrence of non-uniform brightness in the illuminating device 30, and consequently can suppress the occurrence of non-uniform brightness on the display surface of the liquid crystal display device 1.

Compared to Embodiment 1 in which the resin layer is formed on the entire surface of the area 21, this embodiment can reduce the amount of the resin material required to form the resin layer.

Except for the above description, Embodiment 2 is the same as Embodiment 1.

### Embodiment 3

In Embodiments 1, 2, as the surface treatment 22, the resin layer is formed on the surface of the FPC 20 by the printing method. In Embodiment 3, a resin sheet having a predetermined shape is attached via an adhesive to the area 21 of the FPC 20 that is to face the reflecting sheet 34. The resin sheet is preferably a material that has good slidability with respect to the reflecting sheet 34 and does not adhere to the reflecting sheet 34, and can be appropriately selected in accordance with the material or the like of the reflecting sheet 34. For example, polyester, particularly PET (polyethylene terephthalate) can be used.

The thickness of the resin sheet is not particularly limited, but is preferably as small as possible so that the lower limit of the thickness is 10 μm or more.

Similarly to the resin layer formed by the printing method in Embodiments 1, 2, the resin sheet attached to the surface of the FPC 20 prevents the insulating layer on the surface of the FPC 20 from coming into close contact with and adhering to the reflecting sheet 34. Therefore, like Embodiment 1, this embodiment can prevent deformation of the reflecting sheet 34 due to temperature changes. Accordingly, this embodiment can suppress the occurrence of non-uniform brightness in the illuminating device 30, and consequently can suppress the occurrence of non-uniform brightness on the display surface of the liquid crystal display device 1.

Similarly to the surface treatment 22 shown in FIG. 3, the resin sheet may be attached to the entire area 21 of the FPC 20 that is to face the reflecting sheet 34 without forming an opening. Moreover, similarly to the surface treatment 22 shown in FIGS. 4A to 4C, the resin sheet may be attached in a predetermined pattern in the area 21. As described in Embodiment 2, even if the insulating layer on the surface of the FPC 20 is exposed to the reflecting sheet 34 in the area 21, it is possible to prevent adhesion between the insulating layer on the surface of the FPC 20 and the reflecting sheet 34 by appropriately setting the area of the insulating layer to be exposed and the thickness of the resin sheet serving as the surface treatment 22.

An easily sliding layer or irregularities may be formed on the surface of the resin sheet that is to face the reflecting sheet 34 so as to improve the slidability of the resin sheet with respect to the reflecting sheet 34 or to prevent adhesion between them.

Except for the above description, Embodiment 3 is the same as Embodiments 1, 2.

### Embodiment 4

In Embodiments 1 to 3, the surface treatment 22 is applied to the area 21 of the FPC 20 that is to face the reflecting sheet 34. In Embodiment 4, a surface treatment for preventing mutual interference between the FPC 20 and the reflecting sheet 34 is applied to an area of the reflecting sheet 34 that is to face the FPC 20. The surface treatment applied to the reflecting sheet 34 is not particularly limited. For example, a resin layer may be formed by the printing method, as in the case of Embodiments 1, 2. Alternatively a resin sheet may be attached via an adhesive, as in the case of Embodiment 3.

The surface treatment may be uniformly applied to the entire area of the reflecting sheet 34 that is to face the FPC 20. Moreover, similarly to the surface treatment 22 shown in FIGS. 4A to 4C, the surface treatment may be applied in a predetermined pattern in the area of the reflecting sheet 34 that is to face the FPC 20. Even if the surface of the reflecting sheet 34 is exposed to the FPC 20 in the area where the surface treatment is not applied, it is possible to prevent adhesion between the insulating layer on the surface of the FPC 20 and the reflecting sheet 34 by appropriately setting the area of the reflecting sheet 34 to be exposed and the thickness of the surface treatment layer.

It should be noted that Embodiments 1 to 4 are merely illustrative, and the present invention is not limited to these embodiments and can be appropriately changed.

For example, the formation of the resin layer by the printing method and the attachment of the resin sheet are described as the surface treatment applied to the surface of the FPC 20 or the reflecting sheet 34. However, the surface treatment of the present invention is not limited thereto, as long as it can prevent mutual interference between the FPC 20 and the reflecting sheet 34. For example, micro roughness may be formed in the area of one of the FPC 20 and the reflecting sheet 34 that faces the other. The micro roughness can be formed, e.g., by transferring micro roughness formed on the surface of a roller, a mold, or the like. The presence of the micro roughness can reduce the contact area between the FPC 20 and the reflecting sheet 34, which in turn can improve the slidability between the FPC 20 and the reflecting sheet 34, and also can prevent adhesion between them.

At least two of different techniques including the formation of the resin layer by the printing method, the attachment of the resin sheet, and the formation of the micro roughness may be combined as the surface treatment. Moreover, the same or different surface treatment may be applied to the areas of both the FPC 20 and the reflecting sheet 34 that face each other.

The surface treatment may be applied to at least part of the area of at least one of the FPC 20 and the reflecting sheet 34 that faces the other. The surface treatment may also be applied to the area of at least one of the FPC 20 and the reflecting sheet 34 that does not face the other.

In the above description, the surface treatment prevents “adhesion” between the FPC 20 and the reflecting sheet 34. However, the surface treatment of the present invention is not particularly limited, as long as it can prevent mutual interference between the FPC 20 and the reflecting sheet 34. For example, the surface treatment of the present invention also includes a surface treatment for improving the slidability between the FPC 20 and the reflecting sheet 34 when there is no adhesion, but a large coefficient of friction between the FPC 20 and the reflecting sheet 34.

The liquid crystal display device of the present invention is not limited to that shown in FIG. 1. The present invention can be applied to all the liquid crystal display devices in which the FPC is arranged so as to overlap the surface of the illuminating device that is on the opposite side from the liquid crystal panel. A plurality of reflecting sheets may be provided between the light guide plate and the FPC. In this case, the reflecting sheet closest to the FPC can correspond to the reflecting sheet 34 as described above.

All of the above-described embodiments are strictly intended to clarify the technical contents of the present invention. The present invention should not be interpreted as being limited to such specific examples, but should be broadly interpreted, and various modifications of the invention can be made within the sprit and scope of the invention as set forth in the appended claims.

The field of industrial application of the present invention is not particularly limited, and the present invention can be used for all the liquid crystal display devices in which the FPC is arranged so as to overlap the surface of the illuminating device that is on the opposite side from the liquid crystal panel. In particular, the present invention can be suitably used for a thin liquid crystal display device for a portable telephone, a personal data assistant, etc. in which it is difficult to place the FPC and the illuminating device apart.

1. A liquid crystal display device comprising:
a liquid crystal panel;
a flexible printed circuit board that is connected to the liquid crystal panel; and
an illuminating device that illuminates the liquid crystal panel, the flexible printed circuit board being folded back so as to overlap a surface of the illuminating device that is on an opposite side from the liquid crystal panel,
wherein a surface treatment for preventing mutual interference between the flexible printed circuit board and a sheet that constitutes the illuminating device and faces the flexible printed circuit board is applied to at least part of an area of the flexible printed circuit board that faces the sheet or at least part of an area of the sheet that faces the flexible printed circuit board.

2. The liquid crystal display device according to claim 1, wherein the surface treatment is silk printing.

3. The liquid crystal display device according to claim 1, wherein the surface treatment is an attachment of a resin sheet.

4. The liquid crystal display device according to claim 1, wherein the sheet is a reflecting sheet.

5. The liquid crystal display device according to claim 1, wherein the surface treatment includes a urethane resin layer.

6. The liquid crystal display device according to claim 1, wherein the surface treatment includes a polyester sheet.

7. The liquid crystal display device according to claim 1, wherein the surface treatment is applied to the flexible printed circuit board.
